(19) United States
(12) Patent Application Publication
(10) Pub. No.: US 2004/0081191 A1
(43) Pub. Date: Apr. 29, 2004

(54) Method for recognizing station and method for establishing link in home network

(75) Inventors: Oh-Sang Kwon, Suwon-city (KR); Yong-soo Cho, Seoul (KR); Mi-hyun Lee, Seoul (KR); Sang-gyu Nam, Seoul (KR)

Correspondence Address: Anthony P. Onello, Jr., MILLS & ONELLO LLP, Suite 605, Eleven Beacon Street, Boston, MA, 02108, US

(73) Assignee: Samsung Electronics Co., Ltd.

(21) Appl. No.: 10/622,951

(22) Filed: Jul. 18, 2003

(30) Foreign Application Priority Data
Jul. 26, 2002 (KR) 02-44341

(51) Int. Cl. H04L 12/28

(52) U.S. Cl. 370/431; 370/462

(57) ABSTRACT

In a method for recognizing stations in a home network of an OFDM scheme and a method for establishing a link between stations in a home network having a plurality of stations, a node number is assigned to the each station and subchannels corresponding to each node number are assigned to each station, the starting station constructing tones corresponding to the subchannels assigned to its own node number and the node number of the destination station as single OFDM symbol, and placing the OFDM symbol in a frame for transmission, and stations other than the starting station detecting the tones from the frame, recovering the node number using indices of the subchannels obtained from the tones and recognizing the starting station and the destination station. According to this method, it is possible to mitigate or eliminate the overhead needed in recovering data of a specific header in all stations and estimating a channel by detecting a signal in a data transmission between stations while sharing a medium, by demodulating the first OFDM symbol and detecting information on a destination station.

### BACKGROUND OF THE INVENTION

1. Field of the Invention

The present invention relates to a method for recognizing a station and a method for establishing a link in a home network, and more particularly to a method for recognizing a station and transmitting bit loading information, and a method for establishing a link in a home network utilizing orthogonal frequency division multiplexing (OFDM) scheme.

2. Description of the Related Art

Orthogonal frequency division multiplexing (OFDM) refers to a modulation method in which entire bands are modulated by an IFFT (Inverse Fast Fourier Transform) using a plurality of orthogonal subcarriers. A cyclic prefix is inserted at the beginning of every OFDM symbol to avoid inter-symbol interference and inter-subchannel interference, and channel distortion in a receiving terminal is compensated for by the single tab equalizer in the frequency domain. OFDM is advantageous in that it employs a water-filing method that assigns a different number of bits to corresponding subchannels according to a signal-to-noise ratio (SNR) in each subchannel to maximize channel capacity and meet the predetermined probability of bit errors in a channel having inter-symbol interference.

There exists a desired performance, namely, a desired probability of bit errors in the OFDM or a discrete multi-tone (DMT) system. Under this condition, it is necessary to transfer results of channel analysis and estimated information reliability in an initial process in order to obtain maximal channel capacity. The channel analysis in the initialization process calculates a signal-to-noise ratio (SNR) in a subchannel using a transmitted training signal from a transmitting terminal to a receiving terminal. By means of the calculated SNR, bit loading information, which can maximize the channel capacity, is obtained through a “water-filing” method. In an actual data transmission, an encoded signal is transmitted to the receiving terminal according to the number of bits loaded for each subchannel and the receiving terminal receives the encoded signal to decode it according to the number of bits. At this time, both the receiving terminal and the transmitting terminal should have the same bit loading information. Therefore, the bit loading information for obtaining a maximal channel capacity is required to be transmitted to the transmitting terminal from the receiving terminal with high reliability.

Among home network technologies, a Home Phoneline Networking Alliance (HomePNA) adopts existing subscriber phone lines, offering the-advantage that additional new lines are not necessary, while stably transmitting high-speed data. The HomePNA was standardized for 1 Mbps level specifications in 1998 and for 10 Mbps level HomePNA 2.0 specifications.

In the HomePNA system as shown in FIG. 1, a plurality of stations A, B, . . . , E share a single common medium and frame transmission capacity is limited by equal opportunities of channel occupation. Therefore, a station that will transmit data divides frames suitable for a limited transmission capacity and performs a CSMA (Carrier Sense Multiple Access) for each frame in order to transmit it. As a result of CSMA, a channel occupied by one station, can be occupied by another channel during data transmission. Consequently, continuity between a former frame and a next frame is not ensured. Therefore, stations in a network should inspect the destination station included in a received signal and know the information transmitted on transmission channels because the received frame is supposed to pass through different channels in relation to the starting point. In addition, the transmitted data is modulated by a modulation method depending on the channel characteristics of a transmitting terminal. Therefore, a destination station should employ a data modulation method according to the channel through which the frame has passed, so as to recover the data. As described above, the HomePNA system requires methods for checking a destination station to recognize a receiving point and for establishing information according to a channel for recovering data.

The HomePNA system performs channel estimation for each frame to establish channel information so as to compensate for channel distortion of a received signal. By using the established channel information, the HomePNA system recovers a header and compensates for the channel distortion, and then recognizes frame address information and an actual data modulation method from the recovered data.

FIG. 2 shows a frame structure of the HomePNA system. The frame of the HomePNA system includes a preamble field for estimating a channel, a frame control (frame CTRL) field, a destination address (DA) field, a starting address (SA) field, a header having a type length field representing an upper layer protocol or a length of the next data field, a data field, a frame check sequence (FCS) field for detecting a transmission error, a PAD (padding) field for adding data to minimize a length of a frame, and a EOF (End of File) field. The DA field, (SA) field, the header, the data field, and the FCS field constitute an Ethernet packet.

A channel is estimated by using the preamble field value in the shown frame structure. The header including the preamble is modulated into a fixed value at all times. Accordingly, all stations in the network establish channel information whenever they receive a signal through a medium, while other stations, except for a station corresponding to a destination station, stop receiving signals. The destination station recovers data using a modulation method obtained from the header and estimated channel information. As described above, the HomePNA system estimates channels for each frame, establishes channel information, and recovers a header using the estimated channel information, so as to determine a destination address. Therefore, all stations other than the starting station perform the above process. Additionally, since headers of all frames are transmitted through a fixed minimum coded modulation method, efficiency of data transmission is reduced in the case of good channel circumstances.

Since the HomePNA system of OFDM scheme which transmits data in an OFDM symbol unit constitutes a medium-sharing network, transmission capacity is limited and transmitting and receiving terminals can be changed for each frame. Consequently, objective stations of communication link establishment can also become changed. Therefore, it is required to have a frame structure based on efficiency of data transmission, a CSMA for transmitting the next frame, overheads for storing a result of a former frame, and delays. In the OFDM scheme, the transmitting and receiving terminals perform initialization prior to data transmission and are aware of channel establishment information for recovering data, namely, the coefficients of a channel equalizer and bit loading information equally. Therefore, if information of the transmitting terminal included in the received signal from the receiving terminal is inspected, a channel which a signal passes through is known, and the information obtained from the initialization process can be established as required data for recovering the data.

In order to reduce overhead in accordance with processing each header at all stations in the HomePNA system of OFDM scheme, a method for recognizing a destination station is necessary, and it is also required to recognize a starting station so as to know the channel which the frame has passed through.

Further, in the HomePNA system constituting a home network, continuity in transmitting frames through the same link is not ensured. As a result, if many symbols are used in the initialization process, a plurality of initialization frames and areas for storing results of channel analysis in a former initialization frame are additionally required. In addition, in the HomePNA system, the initialisation process requires a lot of time since the processing time becomes long due to CSMA for transmitting a plurality of frames and due to channel occupation by other stations during frame transmission. As a result, the efficiency in transmitting data becomes decreased as the initial delay becomes longer due to the initialization performed before transmitting data. Therefore, the HomePNA system requires a structure of frame and a method for analysing channels efficiently by considering the required time and overhead due to many CSMAs.

In the OFDM system, bit and gain information for which maximal transmission capacity can be obtained under a current bit error rate by using the SNR calculated while analysing the channels is calculated. The bit and gain information is directed to encoding data in an actual transmission and is required to be transmitted with high reliability from the receiving terminal to the transmitting terminal. The bit loading information includes bit and gain information, in which the bit information is indicated as 4 bits by loading 2-15 numbers of bits for each subchannel and the gain information is indicated as 12 bits, so that the total loading information constitutes 2 bytes for each subchannel.

The HomePNA system of the OFDM protocol employs a high frequency band higher than 120 MHz so as not to overlap with existing services using the same telephone lines. Also, in the HomePNA system, since the channel length is limited to 150 m or shorter, attenuation in the high frequency band is not much and there are various spectrum nulls under the influence of a plurality of bridge taps according to a network configuration. In addition, in the HomePNA system, the spectrum nulls can occur in an arbitrary area which a user designates after constructing a network. Hence, it is very dangerous to previously designate a robust subchannel in the same manner as in a system employing an existing telephone line. Therefore, the HomePNA system requires a method for selecting a robust subchannel according to each channel characteristics in the initialization process and transmitting bit information and gain information.

### SUMMARY OF THE INVENTION

It is a first object of the present invention to provide a method for recognizing a destination station, which reduces the overhead of stations other than the destination station in the HomePNA system of the OFDM scheme, and a method for which a destination station recognizes a starting station indicated in a received frame so as to establish channel information obtained through an initialization process in the OFDM scheme according to a channel of the received frame.

It is a second object of the present invention to provide a method for selecting a robust subchannel under predetermined circumstances in the HomePNA system of the OFDM scheme, and to transmit bit loading information.

In one aspect, the present invention provides a method for recognizing stations in a home network of an OFDM scheme, wherein the home network includes starting and destination stations, the method comprising the steps of (a) assigning a node number to each station and assigning subchannels corresponding to the node number of each station, (b) the starting station constructing tones corresponding to the subchannels assigned to its own node number and the node number of the destination station as single OFDM symbol, and placing the OFDM symbol in a frame for transmission, and (c) stations other than the starting station detecting the tones from the frame, recovering the node number using indices of the subchannels obtained from the tones and recognizing the starting station and the destination station.

In another aspect, the present invention provides a method for establishing a link between stations in a home network having a plurality of stations, the method comprising the steps of (a) a starting station constructing a frame including recognition information including a self-address and an address of a destination station, an average noise power reflecting channel properties of the starting station, and a training sequence, and transmitting the frame, (b) the destination station determining whether it is the destination station based on the recognition information and estimating channel power and noise power from the received training sequence, (c) the destination station selecting subchannels by using the estimated channel power, the noise power, and the average noise power, constructing location information of the selected subchannels as an OFDM symbol, and transmitting the OFDM symbol to the starting station, and (d) the starting station recovering the OFDM symbol and detecting a final location of a final subchannel from location information of the subchannels.

### BRIEF DESCRIPTION OF THE DRAWINGS

The above another objects and advantages of the present invention will become more apparent by describing in detail preferred embodiments thereof with reference to the attached drawings in which:

FIG. 1 is a conceptual view of a plurality of stations constituting a HomePNA system sharing a single medium;

FIG. 2 is a view of a data frame structure in the HomePNA system;

FIG. 3 is a block diagram of a modem in the HomePNA system of an OFDM protocol, in accordance with the present invention;

FIG. 4 is a view of a frame structure used in the modem of the HomePNA system of the OFDM protocol, according to the present invention;

FIG. 5 is a view of a frame structure of a forward link initialization in an initialization process which is performed before data transmission;

FIG. 6 is a view of a frame structure of a reverse link initialization in an initialization process for establishing a reverse link in an initialization process;

FIG. 7 is a flow diagram showing a link initialization between a starting station and a destination station during a data transmission process;

FIG. 8 is a graph of noise spectrum existing in a telephone line;

FIG. 9 is a graph of self near-end crosstalk noise;

FIG. 10 is a conceptual view of a path of a signal transceived in the HomePNA system;

FIG. 11 is a conceptual view of recognition tones in a frequency domain;

FIG. 12 is a flow diagram of a data decoding process through detecting recognition tones;

FIG. 13 is a view of average noise power for each group formed by dividing estimated noise power in each subchannel using limited symbols into 4 bands;

FIG. 14 is a view of an example of establishing a forward link and a reverse link according to the present invention;

FIG. 15 is a view of an example of a pattern constituting a notify tone according to the present invention.

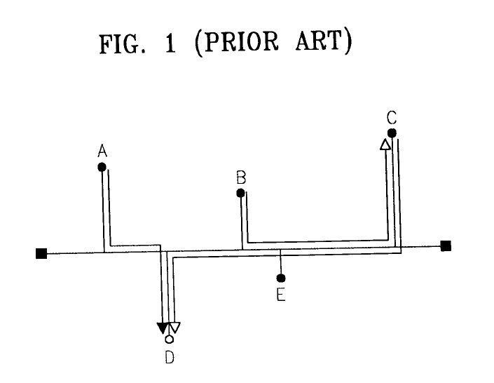

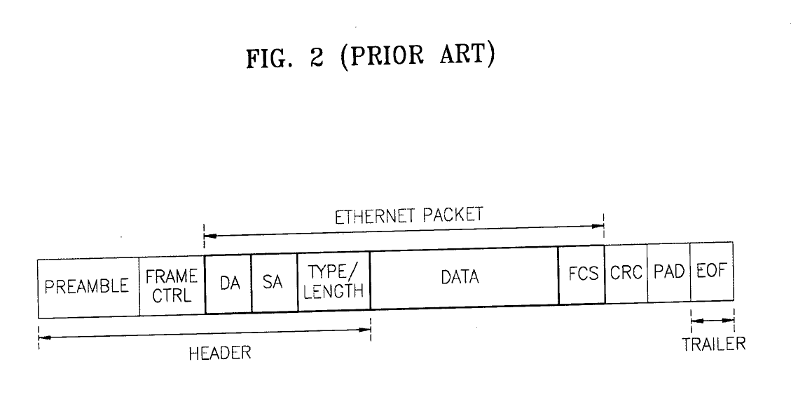

### DETAILED DESCRIPTION OF PREFERRED EMBODIMENTS

While this invention will be particularly shown and described with reference to preferred embodiments thereof, it will be understood by those skilled in the art that various changes in form and details may be made therein without departing from the spirit and scope of the invention as defined by the appended claims.

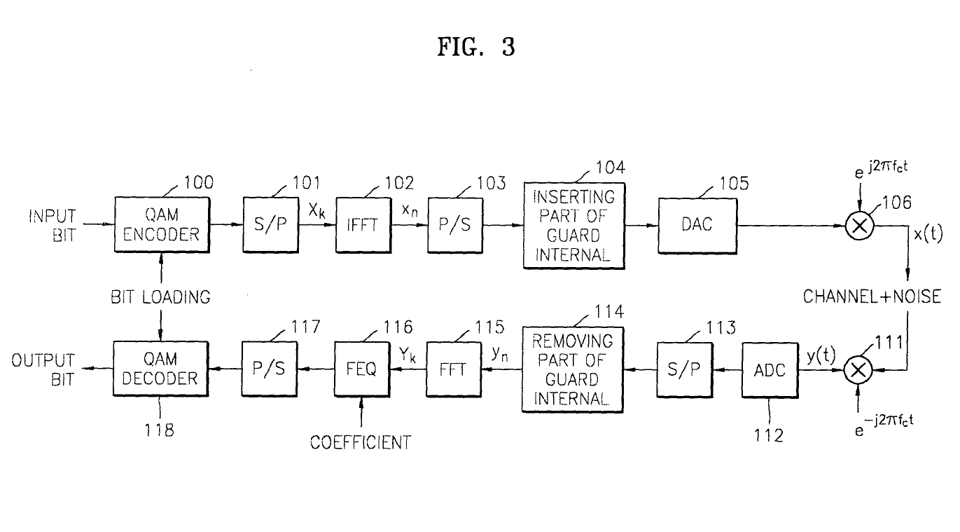

FIG. 3 is a block diagram of a modem in a HomePNA system of an OFDM scheme, to which the present invention is applied. In the HomePNA modem according to FIG. 3, a transmitting terminal includes a QAM (Quadrature Amplitude Modulation) encoder 100, a serial to parallel unit (S/P) 102, an Inverse Fast Fourier Transform unit IFFT 103, a parallel to serial unit (P/S) 103, an inserting unit of a guard interval 104, a digital-to-analog converter DAC 105, and a first mixer 106. A receiving terminal includes a second mixer 111, an analog-to-digital converter ADC 112, a S/P 113, a removing unit of a guard interval 114, a Fast Fourier Transform unit FFT 116, an FEQ (Frequency Domain Equalizer) 116, a P/S unit 117, and a QAM decoder 118.

The QAM encoder 100 modulates input bits according to a QAM modulation method and performs an M-ary mapping of the modulated bits according to bit loading information. The S/P 101 converts serial bits output from the QAM encoder 100 into parallel bits Xₖ. The IFFT 102 converts the parallel bits Xₖ by using each subcarrier into bits xₙ calculated in accordance with the following equation 1.

$${X}_{n} = \frac{1}{\sqrt{N}} {\sum }_{k = 0}^{N - 1} {X}_{k} {ⅇ}^{j2 π k n / N} ( 0 \leq n \leq N - 1 ) \qquad ( 1 )$$

In Equation 1, Xₖ indicates a complex symbol of encoded QAM constellation encoded according to the bit loading information in each subchannel and N indicates the number of subchannels. The P/S 103 converts the IFFTed signal xₙ into serial data again. The inserting unit of the guard interval 104 inserts the guard interval, namely, a cyclic prefix, into a starting part of each serial data. The DAC 105 converts the signal xₙ into an analog signal. The mixer 106 transmits the analog signal carried on a carrier wave through a channel. As the signal passes through a band-limited channel or a wireless channel, noise existing in the corresponding channel is added to the signal passing through the channel. In the receiving terminal, the second mixer 111 converts a received analog signal by using the same carrier wave as that of the transmitting terminal, into a base-band signal. Then, the ADC 112 converts the base-band signal into a digital signal. The removing unit of a guard interval 114 outputs a signal yₙ whose guard interval is removed from the digital signal. The FFT 115 outputs parallel data Yₘ, represented in the following equation, by using a subcarrier.

$${Y}_{m} = \frac{1}{\sqrt{N}} {y}_{n} {ⅇ}^{- j2 π m n / N} ( 0 \leq m \leq N - 1 ) \qquad ( 2 )$$

The FEQ 116 compensates the parallel data for channel distortion by using coefficients and the P/S 117 converts the compensated parallel data into serial data. The QAM decoder 118 performs an M-ray demapping by using the same bit loading information as one of the transmitting terminal and decodes data. Here, the coefficients of the FEQ 116 and the bit loading information are estimated in the initialization process through channel analysis.

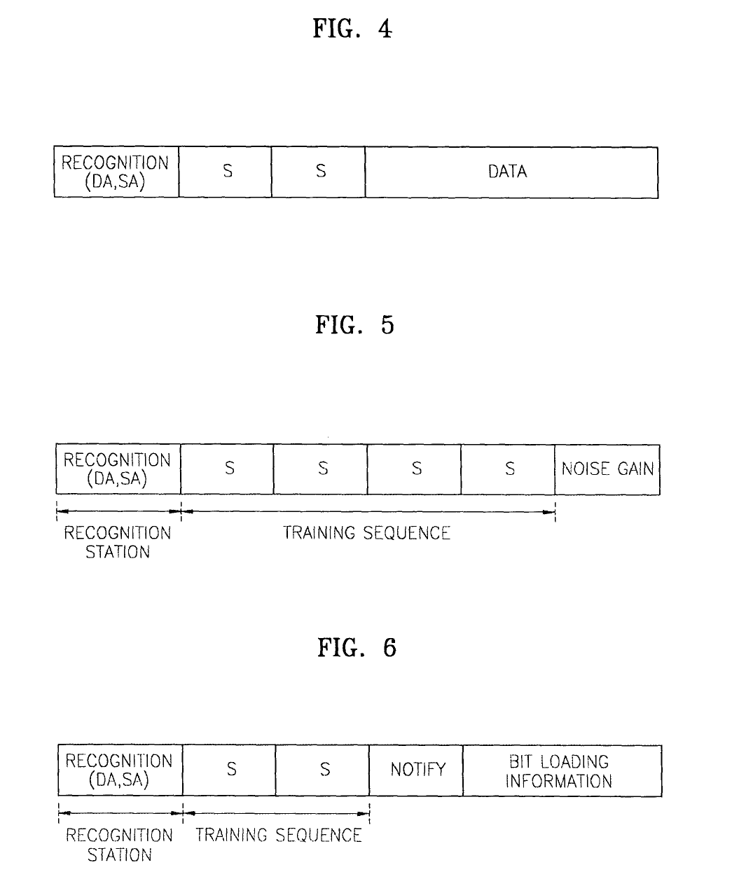

FIG. 4 is a view of a data frame structure used in the OFDM HomePNA modem according to the present invention and FIG. 5 is a view of a frame structure of forward link initialization in the initialization process which is performed before data transmission. FIG. 6 is a view of a frame structure of reverse link initialization for establishing a reverse link in the initialization process.

The forward link initialization frame is transmitted from the transmitting terminal to the receiving terminal for channel analysis before data transmission, and is comprised of a recognition symbol including a starting station address and a destination station address, an S symbol comprised of a training sequence for analyzing channels and a noise gain symbol having an average noise power value of the transmitting terminal.

The reverse link initialization frame is transmitted from the receiving terminal to the transmitting terminal for informing the transmitting terminal of the bit loading information and channel information so as to perform data communication via a corresponding channel with a bit error rate below in actual data transmission. The reverse link initialization frame is composed of a recognition symbol, an S symbol comprised of a training sequence, a notify symbol having information on a robust subchannel for establishing a reverse link, and bit information and gain information obtained during channel analysis.

Here, the training sequence is a cyclic prefix. Since the cyclic prefix is periodic, it does not have to be used when many symbols are used in the sequence. However, when the total number of the cyclic prefixes inserted into a symbol is less than the number of samples of a single OFDM symbol, it is appropriate to use the cyclic prefix in an aspect of signal transmission efficiency.

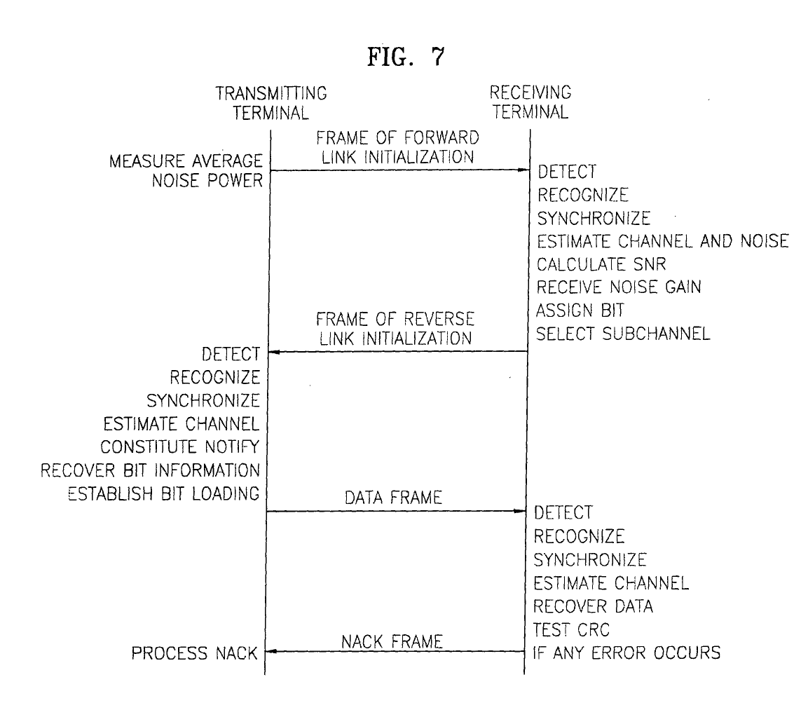

The initialization of a link between the starting station and the destination station and a data transmission process employing the data frame, the forward link-initialization frame and the reverse link initialization frame are shown in FIG. 7.

The forward link is a channel for transmitting data and the reverse link is a channel established for transmitting information estimated by analyzing channels from the receiving terminal to the transmitting terminal. Each frame type for each link is structured as a single frame to be suitable for the HomePNA system so as to avoid overhead such as processing delays due to CSMA.

As shown in FIGS. 4 through 6, the starting station (the transmitting terminal) measures average noise power, inserts the measured average noise power as a noise gain symbol for the forward link initialization frame to prepare the forward link initialization frame, accesses a medium to acquire a channel and transmits the prepared forward link initialization frame to the destination station (the receiving terminal). The noise gain information can be mapped to a OFDM symbol by using QPSK as presented in the following Table 1.

TABLE 1

| Indices of subchannels | Constellation point |
|---|---|
| 0, 10, 20, . . . , 10n | 00 |
| 1, 11, 21, . . . , 10n + 1 | Noise gain bit 0 & 1 |
| 2, 12, 22, . . . , 10n + 2 | Noise gain bits 2 & 3 |
| 3, 13, 23, . . . , 10n + 3 | Noise gain bits 4 & 5 |
| 4, 14, 24, . . . , 10n + 4 | Noise gain bits 6 & 7 |
| 5, 15, 25, . . . , 10n + 5 | Noise gain bits 8 & 9 |
| 6, 16, 26, . . . , 10n + 6 | Noise gain bits 10 & 11 |
| 7, 17, 27, . . . , 10n + 7 | Noise gain bits 13 & 14 |
| 8, 18, 28, . . . , 10n + 8 | Noise gain bits 15 & 16 |
| 9, 19, 29, . . . , 10n + 9 | Noise gain bits 18 & 17 |

Other stations, that is, other than the transmitting terminal, receive the forward link initialization frame and confirm the receiving terminal from the recognition symbol, the first OFDM symbol. Among the stations, a station to which the receiving terminal indicated in the recognition symbol corresponds receives the remainder of the symbols. The receiving terminal performs synchronization, channel and noise estimation, SNR calculation, recovery of noise gain information, bit loading, and subchannel selection, etc. In addition, to transmit the obtained bit loading information to the transmitting terminal, the receiving terminal establishes a subchannel having a higher SNR than the others as the reverse link. Here, the SNR is obtained from the noise gain information included in the forward initialization frame and the estimated channel information. Since the information on establishing the link as described above has to be known in order for the transmitting terminal to recover a signal transmitted through the reverse link, the receiving terminal constructs the reverse link initialization frame, which can transmit the bit loading information and information on a robust subchannel together, acquires a medium and then transmits the reverse link initialization frame. The transmitting terminal receives the reverse link initialization frame and performs the symbol detection, recognition, synchronization, channel estimation, notify tone recovery, and bit information recovery and bit loading information establishment. The transmitting terminal detects information of a selected subchannel in the above process and recovers bit loading information in a corresponding subchannel. The transmitting terminal constitutes a data frame using the recovered bit loading information and transmits it to the receiving terminal. Then, the receiving terminal detects symbols from the data frame, performs recognition, synchronization, and channel estimation, data recovery and CRC (Cyclic Redundancy Check) for checking errors. The receiving terminal recovers the data using the same bit loading information of the transmitting terminal. If the result of the CRC shows any error in a received data frame, the receiving terminal constitutes a frame for NACK (Negative Acknowledgement) to transmit it, and the transmitting terminal processes the frame.

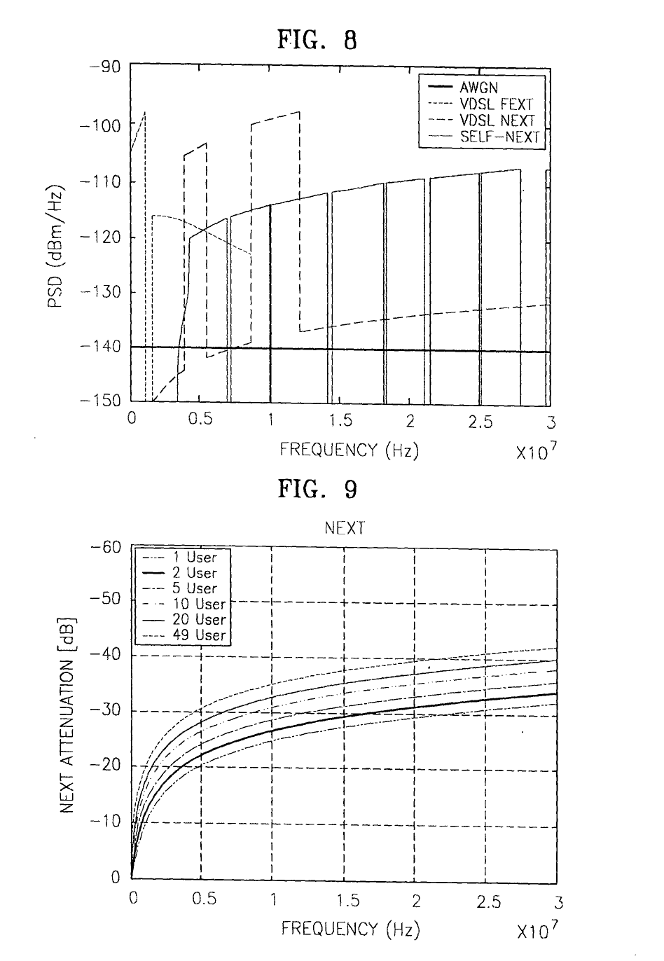

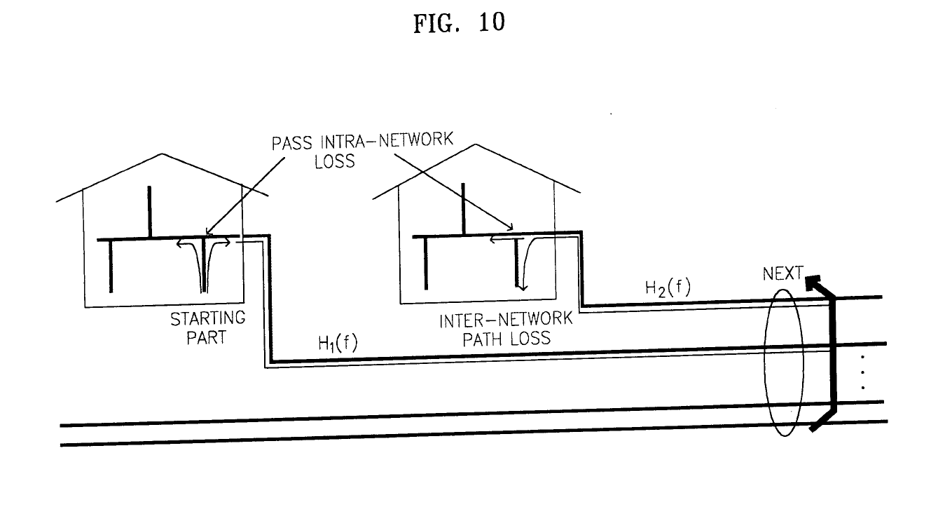

To construct the forward link initialization frame, the transmitting terminal obtains the noise gain information reflecting channel characteristics. The HomePNA system constitutes a network using an existing telephone line in a home and operates in a half duplex mode. Therefore, channel circumstances of the forward and reverse link become changed because noise becomes changed according to locations and surroundings of each station, even though insertion losses of the forward and reverse links are the same. Common telephone lines exhibit noise, such as Additive White Gaussian Noise, Radio Frequency Interference, noise from other services such as ISDN, ADSL and VDSL services, and self-near end crosstalk (self-NEXT). FIG. 8 is a view of a noise spectrum in a telephone line, in which the noise spectrum is dominant in the high frequency area. The HomePNA system is affected most by the self-Next. This is because the HomePNA system is not affected by the existing services due to its superiority in the high frequency area over 12 MHz, owing to the short length of the channel, i.e. 150 m. Power spectrum density of self-NEXT, PSD_{NEXT} is modeled as follows:

$${PSD}_{NEXT} ( f ) = S ( f ) {k}_{N} {{f}^{1.5} ( \frac{{N}_{u}}{49} )}^{0.6} \qquad ( 3 )$$

where k_{N} indicates a constant of NEXT noise, Nᵤ indicates the number of users, and S(f) indicates the PSD (Power Spectrum Density) of a signal transmitted by a corresponding transmitting system. FIG. 9 shows NEXT attenuation modelled using Equation 3. The NEXT can be divided into self-NEXT and foreign-NEXT according to the level of services considering the PSD of a signal. In addition, a signal transceived through a line in the HomePNA system, undergoes at least 3dB of intra-network loss when the signal passes through every node (station). Moreover, loss in the self-NEXT is increased by 6 dB in consideration of outflow of the crosstalk. Therefore, the closer a station is to a binder, the more affected the station is by the crosstalk. The NEXT modelled by Equation 3 is crosstalk within a binder, and in the HomePNA system, as shown in FIG. 10, it is substantially required that inter-network path loss due to transmission lines between a user and a binder should be considered. The inter-networked path loss includes H₁(f), loss that an interference signal undergoes during transmission to a binder, and H₂(f), loss occurred when crosstalk caused by coupling with an interference signal within a binder is transmitted to a subscriber's line as noise. Hence, the inter-networked path loss amounts to 3 dB per 100 ft of transmission line length.

Recognition tones of each frame are placed in a foremost part of the frame so as to recognize a receiving terminal and a transmitting terminal at the very beginning. The recognition tones indicate address information of the transmitting terminal and the receiving terminal and is in the form of unique node numbers that are respectively assigned to the transmitting terminal and the receiving terminal. The unique node numbers are loaded in to each station in a network. The recognition tone is the first OFDM symbol of the frame to be transmitted, and includes node numbers of the receiving terminal and a node number of the transmitting terminal. A transmission band to be used is assigned to each node number and each node number is indicated by a tone according to the corresponding transmission band. Assignment of bands to each node number is expressed in the following Equation 4 as a value calculated by dividing the number of total subcarriers by the maximum number of nodes constituting the network.

M=N/d (4)

where M indicates the number of subchannels assigned to a single node number, N indicates the number of total subcarriers and d indicates the maximum number of nodes.

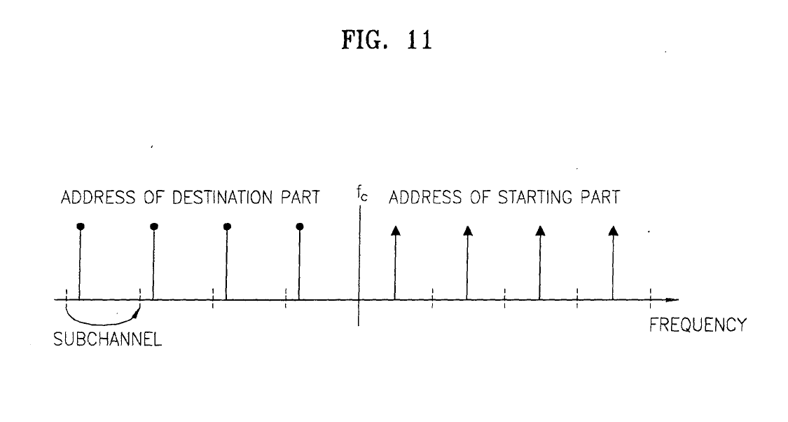

To determine the receiving terminal and the transmitting terminal in consideration of a transmission capacity of the HomePNA system, as shown in FIG. 11, a frequency domain is divided into two parts, a lower band and an upper band. Tones assigned to the receiving terminal are loaded into the lower band and tones assigned to the transmitting terminal are loaded into the upper band. Accordingly, M/2 of tones are loaded in each band.

When subchannels corresponding to each station are sequentially assigned to M/2 consecutive bands according to each node number, the band with spectrum nulls may lose information and the information may not be detected according to channel characteristics. Therefore, it is required to periodically assign tones to the frequency domain, in order that the recognition tone can be transmitted strongly under any unknown circumstances. If tones are assigned periodically to the frequency domain, other locations of repeated tones can be detected due to diversity effects even though subcarrier frequencies are lost under poor channel circumstances.

The following Equation 5 indicates that indices of subchannels according to node numbers are assigned based on a period of the maximum number of nodes d.

Dᵢ=((k mod d)==DSN},k<N/2

Sᵢ={(k mod d)==SSN},k>N/2,i=1, . . . , M/2 (5)

Here, DSN (Destination Station Node number) indicates a node number of a receiving terminal and SSN (Source station Node number) indicates a node number of the transmitting terminal.

A tone R, calculated by following Equation 6, is transmitted via an assigned subchannel.

$${R}_{D - tone} , k is {D}_{i , k < N / 2} \\ {X}_{k} = \{ {R}_{s - tone} , k is {S}_{i , k > N / 2} \\ 0 , others \qquad ( 6 )$$

For example, when the maximum number of nodes in the HomePNA system is 25 and the number of available subcarriers is 200, 4 subcarriers per node are used for addresses of the transmitting terminal and the receiving terminal and tones are assigned to each node number of a destination station and a starting station in each band based on a period of the 25 subchannels.

If recognition tones are formed according to Equation 6, the same symbols are assigned to several tones and large scale IFFT is used, which causes an increase in the Peak-to-Average power Ratio (PAR) in the time domain, as calculated according to the following Equation 7.

$$PAR = 10 {log}_{10} ( \frac{peak power}{average power} ) [ dB ] \qquad ( 7 )$$

To solve this problem, constellation values are assigned to each tone using a QPSK (Quadrature Phase Shift Keying) signal, a phase of which is pseudo-randomly rotated by 0, π/2, π, or 3 π/2, as in the following Equation 8.

Xₖ={0,k≠Sᵢ or Dᵢ, o≦k≦256

{Qₖ, k=Sᵢ, provided Qₖ rotates by pπ/2, p=(k mod 4) (8)

Recognition tones constructed according to the above have the same power as the power of a following training sequence symbol. A recognition symbol constructed according to an address of a station in the OFDM system uses only a few bands among the whole bands and transmission power is also reduced accordingly. Therefore, there may be problems in detecting a signal before detecting a tone, depending on the channel circumstances. In other words, it may be difficult to detect a signal because in a channel greatly affected by noise, a power of a symbol of only a few tones is not strong enough against the noise. Accordingly, a signal \hat{x}ₙ is formed using Equation 9, such that the power of the OFDM symbol can be identical to the power of the training sequence symbol so as to enhance reliability in detecting a signal at a receiving terminal.

$${\hat{x}}_{n} = \sqrt{\frac{N}{M}} * {\overline{x}}_{n} \qquad ( 9 )$$

Here, M indicates the number of subchannels assigned to a single node number and N indicates the number of total subcarriers, and xₙ indicates modulated signals of each subcarrier, namely, signals which undergo IFFT and wherein cyclic prefixes are inserted after the IFFT was performed.

The transmitting terminal transmits a signal, the power which is previously enhanced by the transmitting terminal so as to allow the receiving terminal detect a reliable signal according to Equation 9, such that the power of a symbol becomes strong enough against other channels and noises.

Other stations, except for the transmitting terminal, perform FFT on a received signal, and estimate amplitude of the signal in the subchannel to detect M/2 subchannels whose signal amplitudes are larger than the others in each subcarrier frequency band of the receiving terminal and the transmitting terminal. Since the amplitudes of the signal are different depending on channel circumstances, it is possible to detect recognition tones regardless of the channel circumstances by obtaining M/2 subchannels with relatively larger amplitude without using a predetermined threshold. A node number of a corresponding station is detected through a modulo calculation of an index (kᵢ) of a subchannel corresponding to the detected subcarrier by the maximum number of nodes, d, according to following Equation 10,

Node Number(Sᵢ)=kᵢ mod d, i=1, . . . , M/2 (10)

where kᵢ indicates indices of subchannels and S indicates a node number.

Since several tones are lost under circumstances that channels are greatly affected by noise, a node number can be detected once or more. In this case, most frequently detected node number is selected for a destination station. The receiving terminal is recognized through the selected node number. Other stations, except for the receiving terminal, stop receiving a signal. Then, the receiving terminal detects a node number of the transmitting terminal, through the same method as presented above, in a band of the transmitting terminal of the recognition tone, and recognizes the transmitting terminal.

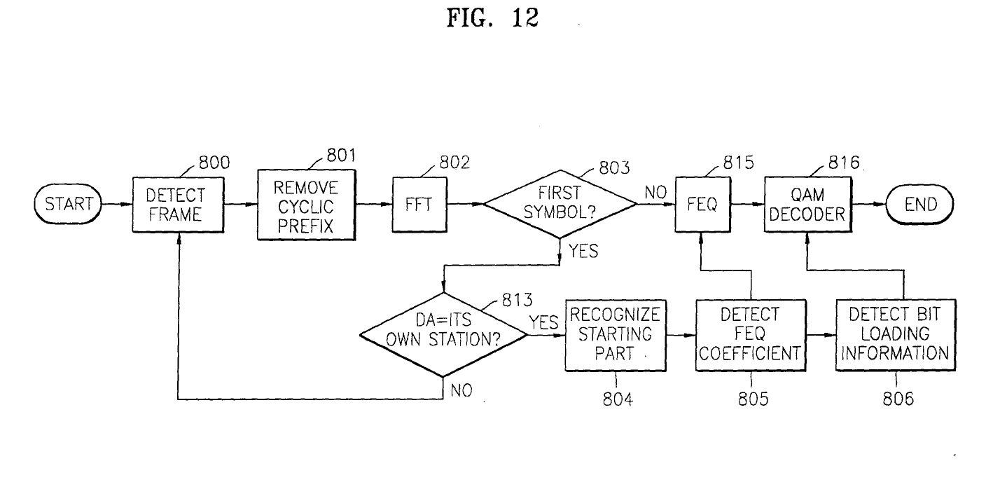

A channel on which a frame passes through is determined based on the information of the starting and destination station. Coefficients of FEQ obtained in the initialization process of the corresponding channels, and bit loading information can be established. FIG. 12 is a flowchart of a data encoding process for detecting recognition tones as described above. According to FIG. 12, frames are detected from a received signal (step 800), cyclic prefixes are removed from the detected frame (step 801), an FFT is performed to output the frame as symbols (step 802). If one of the outputted symbols is the first symbol (step 803), it is determined whether the receiving terminal is a destination station (step 813). If not, the step 800 is performed again. If the receiving terminal is a destination station, a starting station is recognized from symbol data (step 804), and coefficients of FEQ and bit loading information are detected (step 805 and step 806, respectively). If the symbol is not the first symbol in the step 803, the output symbol is equalized with the coefficients of FEQ detected in step 805 (step 815) and is decoded with the bit loading information detected in step 805 (step 816).

The receiving terminal recognizes the transmitting terminal from the forward link initialization frame and stores the recognized transmitting terminal. Then, the receiving terminal estimates the channels and the noise spectrum of each subchannel by analyzing the channels, calculates SNRs, calculates the maximal number of bits and gain distribution which can be loaded under the corresponding channel circumstances, and transmits the bit and gain information, so as to obtain the available maximum transmission capacity.

Channel analysis is performed by using the training sequence known to the transmitting terminal and the receiving terminal. The training sequence xₙ uses QPSK symbols of Xₖ and is a periodic signal having a period of N. Here, the period N is set to be the same as or longer than the length of arbitrary channel response coefficients pₙ. The training sequence transmitted from the transmitting terminal passes through a channel and is received as expressed in the following Equation 11.

yₙ=xₙ*pₙ+uₙ (11)

where uₙ indicates an additive noise having no correlation to xₙ.

Channel estimation obtains an estimation value of the channel response, \hat{p}ₙ, n order that an error signal between the received signal and the channel output of the training sequence can be minimized. The error signal eₙ is calculated according to Equation 12.

eₙ=yₙ−pₙ*\hat{x}ₙ (12)

In Equation 12, xₙ indicates a periodic signal having a period N. Xₘ, demodulated by the FFT to xₙ becomes a periodic signal of period N. When signals yₙ, xₙ, \hat{p}ₙ, uₙ and eₙ in the time domain, correspond to signals Yₘ, Xₘ, \hat{P}ₘ, Uₘ and Eₘ of the frequency domain, respectively, Equation 11 can be expressed in the frequency domain as follows:

Yₘ=Xₘ·Pₘ+Uₘ (13)

Also, the error signal according to the above Equation 12 can be expressed in the frequency domain as follows:

Eₘ=Yₘ−\hat{P}ₘ·Xₘ m=0, . . . ,N (14)

The estimated value of the channel response which makes an MSE (Mean Square Error) of the error signal be minimized, has an error δₙ=pₙ−\hat{p}ₙ in the time domain which can be expressed in the frequency domain as, Δₘ=Pₘ−\hat{P}ₘ. If the estimated value \hat{P} of the channel response is the same as an actual channel response P, the error of the estimated value δ is 0 and the error signal eₙ according to the channel estimation is equal to uₙ.

The channel response at the receiving terminal is calculated by dividing a received signal in the frequency domain by the training sequence in the frequency domain, and the channel estimation value \hat{p}ₘ is therefore expressed as follows:

$${\hat{P}}_{m} = \frac{I}{L} {\sum }_{i - 1}^{L} \frac{{Y}_{1 , m}}{{X}_{1 , m}} \qquad ( 15 )$$

where L indicates the number of symbols.

The received signal in the frequency domain is expressed as in Equation 16, where Y_{l,m} indicates an output from the lth symbol, mth subchannel.

Y_{l,m}=X_{l,m}·Pₘ+U_{l,m} (16)

When Equation 16 is substituted in Equation 15, the estimated value \hat{P}ₘ in the frequency domain is given by following Equation 17:

$${P}_{m} = {\hat{P}}_{m} + \frac{I}{L} {\sum }_{i - 1}^{L} \frac{{U}_{1 , m}}{{X}_{1 , m}} \qquad ( 17 )$$

The error of the estimated value calculated from Equation 17 is expressed as follows:

$${Δ}_{m} = - \frac{I}{L} {\sum }_{i - 1}^{L} \frac{{U}_{1 , m}}{{X}_{l , m}} \qquad ( 18 )$$

where X_{l,m} is expressed as X_{l,m}=|X|e^{f0}^{_{l,m}}, a sequence of a predetermined size, After estimating the channel response coefficients, an error of the received signal in each subchannel is calculated by the following Equation 19.

$${E}_{m} = {Y}_{m} - {\hat{P}}_{m} \cdot {X}_{m} = {Δ}_{m} \cdot {X}_{m} + {U}_{m} = {U}_{m} + \frac{I}{L} {\sum }_{k = 1}^{L} {U}_{l , m} {ⅇ}^{j ( {θ}_{m} - {θ}_{l , m} )} \qquad ( 19 )$$

The MSE of the error signal expressed by Equation 19 is decreased with an increase in the number of symbols (L).

Noise power can be estimated at the same time along with the channel estimation and is obtained by removing the estimated value of the channel response from the received signal and using the remaining dispersion of the error sequence, Eₘ.

Equation 20 presents the noise power spectrum obtained from the dispersion of the error sequence of L sample in the mth subchannel.

$$\hat{{σ}_{m}^{2}} = \frac{1}{L} {\sum }_{i = 1}^{L} {\vert {E}_{l , m} \vert}^{2} \qquad ( 20 )$$

The SNR is calculated using powers of the estimated channel and noise in each subchannel as follows:

$${SNR}_{m} = \frac{{ϵ}_{m} \cdot {\vert \hat{{P}_{m}} \vert}^{2}}{\hat{{σ}_{m}^{2}}} \qquad ( 21 )$$

The SNR calculated by Equation 21 is used to assign bits to the mth subchannel according to Equation 22, so as to satisfy a performance level of 10e-7 BER (Bit Error Rate).

$${b}_{m} = {log}_{2} ( 1 + \frac{{SNR}_{m}}{Γ} ) , {SNR}_{m} = \frac{{ϵ}_{m} {\vert \hat{{P}_{m}} \vert}^{2}}{{\vert \hat{{σ}_{m}} \vert}^{2}} , Γ = 9.8 + {γ}_{m} - {γ}_{c} \qquad ( 22 )$$

where SNRₘ indicates an SNR of the mth subchannel, εₘ indicates power of a symbol assigned to each subchannel, |\hat{P}ₘ |² and |\hat{σ}ₘ|² indicate respectively an attenuation rate and noise power in each subchannel, Γ indicates an SNR-gap satisfying the performance level of 10e-7 BER, and γₘ and γ_{c} indicate a noise margin and coding gain respectively.

The total number of bits that a single OFDM symbol carries during a symbol period via the modem of the OFDM scheme is expressed by

$$b = {\sum }_{m = 0}^{N - 1} {b}_{m} ,$$

and transmission capacity is given by,

$$R = \frac{B}{N + {N}_{cp}} \cdot b \qquad ( 23 )$$

where B indicates occupied bandwidth and N_{CP} indicates the length of a cyclic prefix.

The noise estimation process at the receiving terminal is as follows. A channel is estimated using the training sequence at the receiving terminal and, at the same time, an average noise power is estimated using the error signal according to the estimated value of the channel. The higher the number of symbols in the channel analysis processing, the less the average deviation of each estimated error. However, in the HomePNA system, overhead is required due to the use of many frames and additional long delays in analyzing the channel using a lot of symbols. To solve this problem, a method for analyzing the channel using the limited number of symbols within a frame is desired. Since the HomePNA system is used for the interconnection of home appliances, the distance between stations is not long and noise is primarily determined by the self-NEXT value. Accordingly, the present invention employs a technique for reducing the average deviation of an estimated value of noise using self-NEXT by using limited symbols in the channel analysis. Referring to FIG. 9, the amplitude of the self-NEXT is increased in proportion with higher frequencies, but the increase in bands of 12 MHz to 30 MHz is not large enough to show a difference of 4 dB. This also shows that the difference between the noise spectrums of each subchannel is not large. The number of samples, which is required for estimating the noise spectrum of each subchannel and reducing the average deviations of the estimated noise spectrums below a predetermined level is larger than the one of the symbols used in channel analysis. Therefore, the average deviation of the corresponding subchannel becomes reduced by using samples of neighboring subchannels, in which deviation from the estimated value of noise for each subchannel is not large. In other words, information on the noise spectrums of the neighboring subchannels may be additionally used to estimate the noise spectrum for each subchannel in order to reduce the average deviation of the estimated value of the corresponding subchannel. For example, L samples are assumed to be required to reduce the average deviation of an estimated value of the noise estimation value below a predetermined level. If L/10 samples are employed, a group is configured to use the neighboring 10 subchannels in order to estimate the average noise power. The noise spectrum can be estimated in a group in each subchannel as follows:

$${\tilde{N}}_{i} = \frac{N}{G} {\sum }_{m = l \frac{N}{G}}^{( l + 1 ) \frac{N}{G} - 1} \hat{{σ}_{m}^{2}} , l = 0 , ⋯ , G - 1 \qquad ( 24 )$$

where G indicates a value calculated by dividing a whole band into the number of groups. The noise spectrum calculated according to Equation 24 is applied to all subchannels within a group in the same manner, according to Equation 25.

$$\begin{matrix}{\tilde{N}}_{0} , 0 \leq k \leq \frac{N}{G} - 1 \\ {\hat{N}}_{k} = \{ {\tilde{N}}_{1} , \frac{N}{G} \leq k \leq \frac{2 N}{G} - 1 \\ ⋮ \\ {\tilde{N}}_{G - 1} , \frac{( G - 1 ) N}{G} \leq k \leq N - 1\end{matrix} \qquad ( 25 )$$

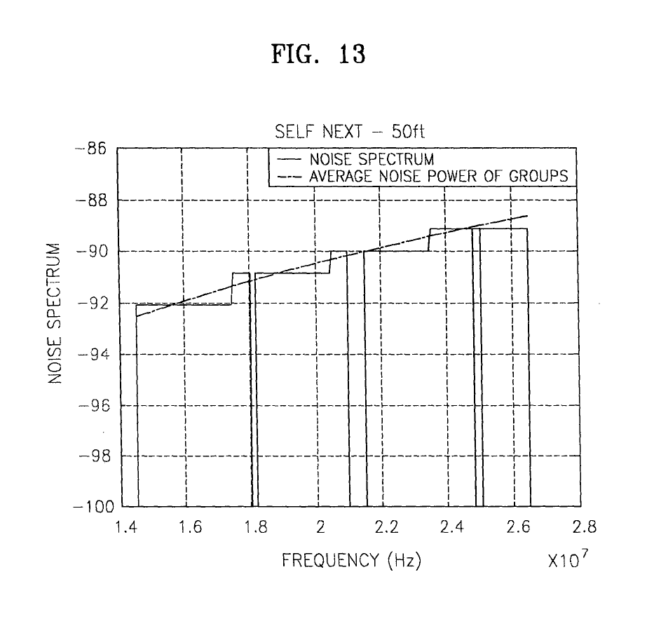

FIG. 13 is a view of average noise power for each group obtained by dividing the estimated noise powers in each subchannel using a limited symbol into 4 bands.

After the channel and noise estimation using a training sequence, an SNR in a subchannel is calculated using the estimated channel power and noise spectrum. Bit and gain information in the corresponding subchannel are estimated by using a loading algorithm such as a well known rate-adaptive loading criterion or margin-adaptive loading criterion.

In order to correctly transmit the estimated bit and gain information to the transmitting terminal, a robust reverse link has to be established. Since the HomePNA system accesses a medium by CSMA, channel performance is affected due to changes in noise according to the location and environment of a station. Accordingly, the receiving terminal can detect the noise of the transmitting terminal, and it is possible to estimate channel performance of a reverse link by using the estimated channel information.

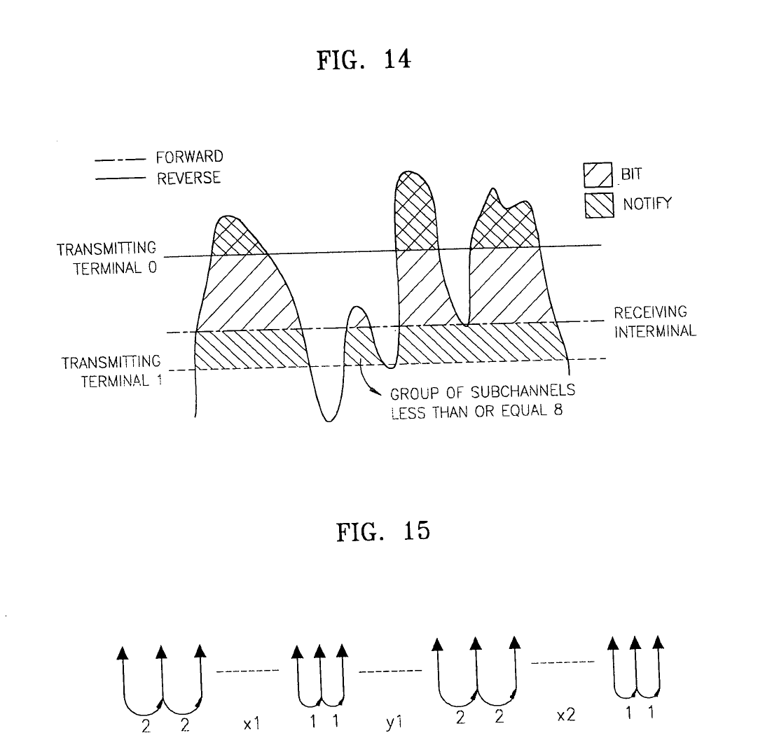

Hence, in compensating for channel distortion by using the noise gain information and estimated channel information and recovering the average noise power transmitted from the transmitting terminal, the channel performance of the reverse link is estimated. Since a lot of data is not actually transmitted by the reverse link, reliability should be given priority over the maximization of the channel capacity in link establishment. Namely, subchannels having good SNR should be selected. Reverse links are established by using a band, which forms a group of consecutively selected subchannels among total selected subchannels. FIG. 14 shows the forward link and reverse link under poor performance conditions. As shown, selected subchannels are grouped into 3 groups. A transmitting terminal 1 whose reverse link characteristics are good such that many robust subchannels can be selected, transmits the bits and gain information more quickly and using fewer symbols than the transmitting terminal 0.

In order to correctly recover data transmitted through the reverse link, the transmitting terminal should be aware of the same information on robust subchannels of the established reverse link as the receiving terminal. Therefore, the receiving terminal is required to transmit the information on the robust subchannels to the transmitting terminal. To achieve this, the present invention employs a notify tone. The notify tone includes the location information of the robust subchannels selected by the receiving terminal. The transmitting terminal uses a method for measuring the power of each subchannel to detect the corresponding subchannel in order to recover the notify tone. However, if only a portion of the robust subchannels is selected, tones are inserted only to the corresponding frequency band, such that a certain signal in the time domain becomes large. Further, there is no way to determine any tone lost upon transmission, and so the transmitting terminal may recognize erroneous tones. If the transmitting terminal detects erroneous link establishment information, bit loading information is not recovered correctly and the communication link is established incorrectly. Therefore, the HomePNA system preferably utilizes a method for confirming the recovered information as well as transmitting location information of a subchannel using the notify tone. Since channel spectrums are affected by spectrum null caused by bridge taps and an RFI band, the robust subchannels are selected consecutively to form groups. Accordingly, the receiving terminal does not carry tones on all of the groups of the robust channels and instead forms tones in a starting part and an ending part of each group. By this structure, tones are formed in such an organically associated pattern, such that a possibility that the notify tone symbol has a certain large amplitude in the time domain can be reduced and detection errors of the notify tone can also be reduced. FIG. 15 shows an example of a pattern constituting the notify tone according to the present invention. As shown in FIG. 15, a group pattern of robust channels has 3 tones loaded into a starting part in a period of 2 subchannels and 3 tones loaded into an ending part in a period of a single subchannel. In this case, the minimum number of subchannels needed to form the group is 8. In general a group having at least 8 subchannels is preferred for providing signal stability.

The transmitting terminal receives the notify tone symbols transmitted from the receiving terminal through the reverse link, and the following two steps are performed for detecting the notify tone reliably. First, the receiving terminal calculates an SNR by using the power of the received signal and an average noise power measured in each subchannel and detects a subchannel having an SNR, which is larger than a predetermined threshold. Secondly, the receiving terminal tests the detected subchannels using the pattern shown in FIG. 15, and finally, determines locations of the robust subchannels. Through the pattern rate, locations detected erroneously are excluded. Here, if transmitted tones are lost when the subchannels are detected using only the signal power, the locations of the subchannels cannot be found through the pattern test and a pattern test for a group to which the lost tones belong also exhibits errors so that information on the group cannot be detected. Therefore, it is required to set a threshold value properly so as to prevent tones from being lost and to allow robust subchannels to be selected.

Bit loading information as well as the notify tone having location information on the selected robust subchannels are included in the reverse link frame. The bit loading information includes bit and gain information to be used for each subchannel at the transmitting terminal in which the bit loading information is loaded in only the selected subchannels through a QPSK scheme in ascending order of its indices. Here, the bit and gain information refers to the number of bits to be coded and a gain value of an mth subchannel. The bit information can be expressed by 4 bits and the gain information can be expressed by 12 bits. Therefore, the size of information to be transmitted for a single subchannel is 2 bytes.

According to the present invention, it is possible to mitigate the amount of overhead required for data recovery for a predetermined portion of header and channel estimation at every station in a network by demodulating a first OFMD symbol to detect information on a destination station after detecting a signal in data transmission between the stations sharing a single medium. In addition, when forming a reverse link frame in order to transmit estimated information in an initialization process, it is possible to create a recognition symbol using only a process of exchanging a destination station and a starting station of recognition information as recovered from a forward link initialization frame and to establish each link using one frame.

In addition, initial delay time due to the initialization process can be reduced by transmitting bit and gain information. In this case, a system transmits 16N bit information and 3/4N subchannels carry 2 bit information. Therefore, 11 symbols are enough to transmit bits and gain information, which requires smaller capacity than that of an Asymmetric Digital Subscriber Line (ADSL) using 516 symbols under the same circumstances.

Further, since the present invention selects robust subchannels after analyzing diverse channel circumstances of the HomePNA system, previous determination of subcarriers in a low frequency band of each channel is not required, as in the ADSL. Therefore, reliability in establishing a reverse link is enhanced and efficiency of bit loading information transmission owing to transmission of the bit loading information to the selected subchannels is increased.

While this invention has been particularly described with reference to preferred embodiments thereof, it will be understood by those skilled in the art that various changes in form and details may be made therein without departing from the spirit and scope of the invention as defined by the appended claims.

What is claimed is:

1. A method for recognizing stations in a home network of an OFDM-based system, wherein the home network includes starting and destination stations, the method comprising the steps of:
(a) assigning a node number to each station and assigning subchannels corresponding to the node number of each station;
(b) the starting station constructing tones corresponding to the subchannels assigned to its own node number and the node number of the destination station as single OFDM symbol, and placing the OFDM symbol in a frame for transmission; and
(c) stations other than the starting station detecting the tones from the frame, recovering the node number using indices of the subchannels obtained from the tones, and recognizing the starting station and the destination station.

2. The method for recognizing stations in a home network as claimed in claim 1, wherein the number of subchannels assigned to each node number in step (a) is calculated by dividing the number of total subcarriers by the number of nodes included in the home network.

3. The method for recognizing stations in a home network as claimed in claim 1, wherein the assignments of subchannels in step (a) are performed according to the following equation:
Dᵢ=((k mod d)==DSN},k<N/2
Sᵢ={(k mod d)==SSN},k>N/2,i=1, . . . ,M/2,
where N indicates the number of total subcarriers, DSN indicates a node number of the destination station, SSN indicates a node number of the starting station, Dᵢ indicates an index of a subchannel assigned to the destination station, and Sᵢ indicates an index of a subchannel assigned to the starting station.

4. The method for recognizing stations in a home network as claimed in claim 1, wherein the OFDM symbol is placed in a foremost part of the frame in step (b).

5. The method for recognizing stations in a home network as claimed in claim 4, wherein in step (c) a station that determines that it is the destination station receives additional symbols of the frame, while stations other than the destination station do not receive the additional symbols of the frame.

6. The method for recognizing stations in a home network as claimed in claim 1, wherein the tones in step (b) that are assigned to the starting station are loaded into an upper band centering about a subcarrier frequency and the tones assigned to the destination station are loaded into a lower band centering about the same subcarrier frequency.

7. The method for recognizing stations in a home network as claimed in claim 1, in which phases of the tones in step (b) are rotated pseudo-randomly according to following equation:
Xₖ={0, k≠Sᵢ or Dᵢ, o≦k≦256
{Qₖ, k=Sᵢ, provided Qₖ lotates by pπ/2, p=(k mod 4),
where Dᵢ indicates indices of subchannels assigned to the destination station, and S, indicates indices of subchannels assigned to the starting station.

8. The method for recognizing stations in a home network as claimed in claim 1, wherein the node number detection in step (c) is performed by detecting the node number of a corresponding station by modulo-calculating the indices of the subchannels by the maximum number of nodes constituting the home network.

9. The method for recognizing stations in a home network as claimed in claim 8, wherein a node number that is most frequently detected is selected, if the node number is detected at least once.

10. The method for recognizing stations in a home network as claimed in claim 1, wherein the tone in step (b) is expressed as
$${\hat{x}}_{n} = \sqrt{\frac{N}{M}} * {\tilde{x}}_{n}$$
in the time domain in order to have the same power as the power of subsequent OFDM symbols,
where M indicates the number of subchannels assigned to a single node number, N indicates the number of total subcarriers, and \tilde{x}ₙ indicates each modulated subcarrier in which a cyclic prefix is inserted.

11. A method for establishing a link between stations in a home network having a plurality of stations, the method comprising the steps of:
(a) a starting station constructing a frame including recognition information including a self-address and an address of a destination station, an average noise power reflecting channel properties of the starting station, and a training sequence, and transmitting the frame;
(b) the destination station determining whether it is the destination station based on the recognition information and estimating channel power and noise power from the received training sequence;
(c) the destination station selecting subchannels by using the estimated channel power, the noise power, and the average noise power, constructing location information of the selected subchannels as an OFDM symbol, and transmitting the OFDM symbol to the starting station; and
(d) the starting station recovering the OFDM symbol and detecting a final location of a final subchannel from location information of the subchannels.

12. The method for establishing a link between stations in a home network as claimed in claim 11, wherein the average noise power in step (a), which is based on a self-Near End crosstalk, is modeled according to the following equation:
$${PSD}_{NEXT} ( f ) = S ( f ) {k}_{N} {{f}^{1.5} ( \frac{{N}_{u}}{49} )}^{0.6} ,$$
where k_{N} indicates a constant value of the self-Near End crosstalk, Nᵤ indicates the number of users, and S(f) indicates the power spectrum density of a signal transmitted from a corresponding transmission system.

13. The method for establishing a link between stations in a home network as claimed in claim 11, wherein the average noise power in step (a) is mapped to an OFDM symbol by QPSK and is loaded in the frame.

14. The method for establishing a link between stations in a home network as claimed in claim 11, wherein the estimation of the noise power in step (b) is performed using noise spectrum information of neighboring subchannels within a same group to detect the average noise power of the corresponding subchannel according to the following equation:
$${\tilde{N}}_{l} = \frac{N}{G} {\sum }_{m = l \frac{N}{G}}^{( l + 1 ) \frac{N}{G} - 1} \hat{{σ}_{m}^{2}} , l = 0 , ⋯ , G - 1 ,$$
where G indicates the number of groups to whole subchannels, L indicates the number of samples, and \hat{σ}ₘ² indicates a noise spectrum obtained from error signal dispersion according to the L samples in a mth subchannel.

15. The method for establishing a link between stations in a home network as claimed in claim 14, wherein the noise spectrum of the subchannel within the same group is applied in the same manner to the other subchannels within the group.

16. The method for establishing a link between stations in a home network as claimed in claim 11, wherein the selection of the subchannels in step (c) comprises the substeps of:
calculating a signal-to-noise ratio of each subchannel by using the estimated channel power and noise power;
recovering the average noise power transmitted from the transmitting terminal by using the estimated channel power;
selecting subchannels according to a higher order of signal-to-noise ratios in comparison with the recovered average noise power; and
forming a reverse link by using a band that is formed of a group of consecutively selected subchannels.

17. The method for establishing a link between stations in a home network as claimed in claim 16, wherein the location information of the subchannels is loaded as tones into a starting part and an ending part of the group to form the OFDM symbol.

18. The method for establishing a link between stations in a home network as claimed in claim 17, wherein the detection of the locations in step (d) comprises the substeps of:
calculating signal-to-noise ratios from the power of the received signal and the average noise power in each subchannel and detecting subchannels having an SNR higher than a predetermined threshold value; and
detecting locations of the detected subchannel according to a manner in which the tones are loaded into the group.

19. The method for establishing a link between stations in a home network as claimed in claim 11, wherein, in step (c), the frame further comprises bit loading information, which includes the number of bits and a gain value to be coded in the starting station and the frame is transmitted through the selected subchannels.

20. The method for establishing a link between stations in a home network as claimed in claim 19, wherein the number of bits is assigned by using the signal-to-noise ratio according to the following equation:
$${b}_{m} = {log}_{2} ( 1 + \frac{{SNR}_{m}}{Γ} ) , {SNR}_{m} = \frac{{ϵ}_{m} {\vert {\hat{P}}_{m} \vert}^{2}}{{\vert {\hat{σ}}_{m} \vert}^{2}} , Γ = 9.8 + {γ}_{m} - {γ}_{c} ,$$
where SNRₘ indicates an SNR of an mth subchannel, εₘ indicates symbol power assigned to each subchannel, |\hat{P}ₘ|² and |\hat{σ}ₘ|² respectively indicate an attenuation rate and noise power in each subchannel, Γ indicates an SNR-gap satisfying a performance level of 10e-7 BER, and γₘ and γ_{c} indicate a noise margin and coding gain, respectively.
